(19) United States
(12) Patent Application Publication
(10) Pub. No.: US 2010/0122996 A1
(43) Pub. Date: May 20, 2010

(54) COMBINATION OF SCREW NAIL GUN AND NAIL BELT

(76) Inventor: Chung-Yen HO, Taichung City (TW)

Correspondence Address: Muncy, Geissler, Olds & Lowe, PLLC, P.O. BOX 1364, FAIRFAX, VA, 22038-1364, US

(21) Appl. No.: 12/547,913

(22) Filed: Aug. 26, 2009

(30) Foreign Application Priority Data
Nov. 20, 2008 (TW) 97144859

(51) Int. Cl. B25C 1/00

(52) U.S. Cl. 227/136

(57) ABSTRACT

A combination of screw nail gun and nail belt includes a screw nail gun, which has a gun body extending along an axis perpendicular to a nailing surface, a nailing nozzle connected to the front end of the gun body and having a front alignment face, a nail holder connected to the nailing nozzle and defining with the nailing surface an acute angle, and a cover covering the nail holder and defining with the nail holder a nail groove, and a nail belt, which includes a belt body set in the nail groove and a plurality of screw nails fastened to the belt body, one screw nail being positioned in the nailing nozzle for nailing, the screw nail positioned in the nailing nozzle having the head thereof partially protruding beyond the front alignment face of the nailing nozzle to facilitate alignment during nailing.

### BACKGROUND OF THE INVENTION

1. Field of the Invention

The present invention relates to nail gun technology and more particularly to a combination of screw nail gun and nail belt.

2. Description of the Related Art

Referring to FIG. 1, a regular screw nail gun 1 comprises a gun body 11 and a nailing nozzle 12 connected to the front end of the gun body 11. Further, a nail belt 2 is mounted in the screw nail gun 1. The nail belt 2 comprises a belt body 21 and a plurality of screw nails 22. The belt body 21 of the nail belt 2 is inserted into the nailing nozzle 12 of the gun body 11.

The screw nail 22 to be nailed is not kept inside the nailing nozzle 12. The user can simply use the nailing nozzle 12 for aiming. Using the nailing nozzle 12 for aiming cannot keep the screw nail in accurate alignment with the workpiece, lowering the construction quality.

Further, the belt body 21 of the nail belt 2 is molded from a flexible plastic material. During operation of the screw nail gun 1, the nail belt 2 may vibrate, interfering with the nailing operation.

Therefore, it is desirable to provide a combination of screw nail gun and nail belt that eliminates the aforesaid drawbacks.

### SUMMARY OF THE INVENTION

The present invention has been accomplished under the circumstances in view. It is one object of the present invention to provide a combination of screw nail gun and nail belt, which facilitates nailing operation and improves construction quality.

To achieve this and other objects of the present invention, a combination of screw nail gun and nail belt comprises a screw nail gun and a nail belt. The screw nail gun comprises a gun body extending along an axis perpendicular to a nailing surface, a nailing nozzle connected to the front end of the gun body and having a front alignment face, a nail holder connected to the nailing nozzle and defining with the nailing surface an acute angle, and a cover covering the nail holder and defining with the nail holder a nail groove. The nail belt comprises a belt body set in the nail groove and a plurality of screw nails fastened to the belt body. One screw nail is positioned in the nailing nozzle for nailing. The screw nail that is positioned in the nailing nozzle has the head thereof partially protruding beyond the front alignment face of the nailing nozzle to facilitate alignment during nailing.

The invention keeps the screw nail that is positioned in the nailing nozzle in such a position that the head of the screw nail partially protrudes beyond the front alignment face of the nailing nozzle to facilitate alignment during nailing, improving nailing precision. Further, based on the design of the acute angle defined between the nail holder and the nailing surface, the screw nail gun can be operated conveniently in a corner area.

### BRIEF DESCRIPTION OF THE DRAWINGS

Other and further benefits, advantages and features of the present disclosure will be understood by reference to the following specification in conjunction with the accompanying drawings, in which like reference numbers indicate like elements of structure.

FIG. 1 is a schematic side view showing a combination of screw nail gun and nail belt according to the prior art.

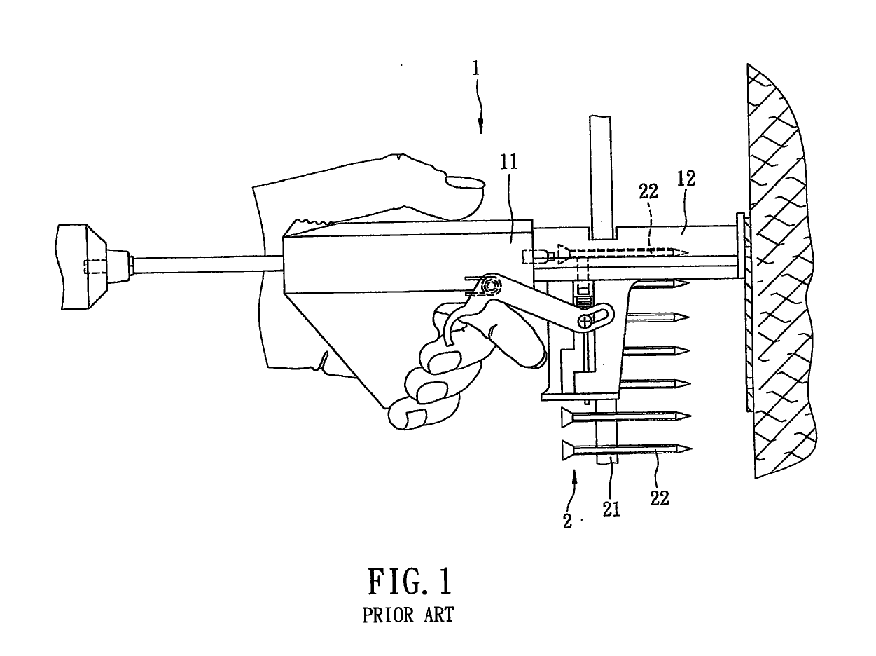

FIG. 2 is a schematic side view showing a combination of screw nail gun and nail belt according to the present invention.

### DETAILED DESCRIPTION OF THE INVENTION

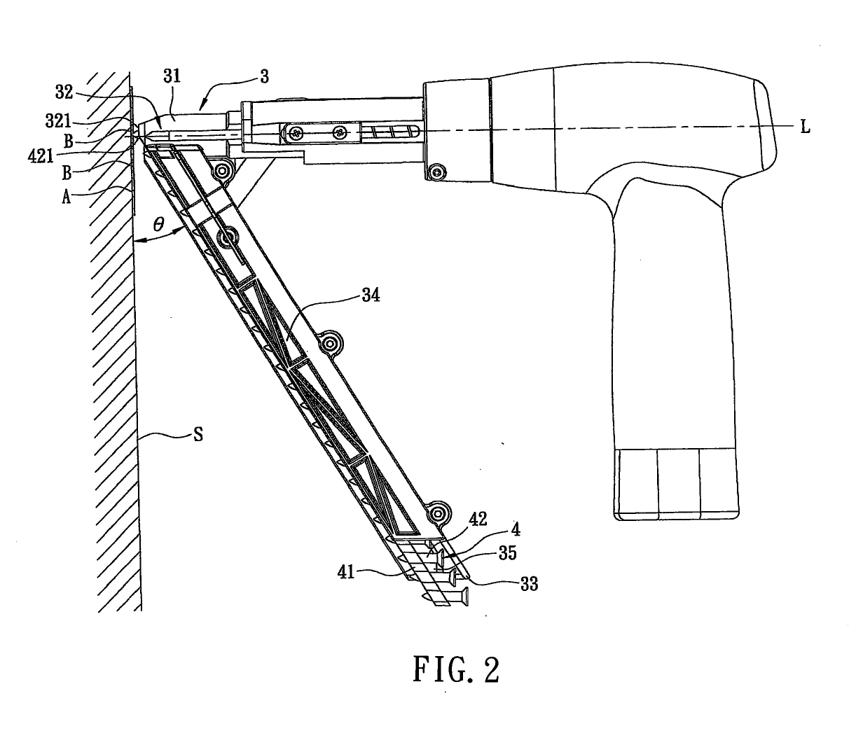

Referring to FIG. 2, a combination of screw nail gun and nail belt is shown comprising a screw nail gun 2 and a nail belt 3.

At first, define an axis L and a nailing surface S perpendicular to the axis L.

The screw nail gun 2 comprises a gun body 31 extending along the axis L, a nailing nozzle 32 connected to the front end of the gun body 31, a nail holder 33 connected to the nailing nozzle 32, a cover 34 covering the nail holder 33, and a nail groove 35 defined in between the nail holder 33 and the cover 34.

The nailing nozzle 32 has a front alignment face 321 at the front side.

The nail groove 35 is adapted for receiving the nail belt 4. The nail holder 33, cover 34 and nail groove 35 define with the nailing surface S an acute angle θ. According to the present preferred embodiment, this acute angle is within the range of 200°˜35°, or preferably 26°.

Based on the design of the acute angle 0 between the nail holder 33 and the nailing surface S, the screw nail gun 3 can be operated conveniently in a corner area. Further, under a normal work condition, the screw nail gun 3 has the characteristic of ease of use, improving construction quality.

The nail belt 4 is set in the nail groove 35, comprising a belt body 41 and a plurality of screw nails 42 fastened to the belt body 41.

According to the present preferred embodiment, the belt body 41 of the nail belt 4 is injection molded from a hard plastic material fitting the angle of slope of the nail groove 35. Further, because the belt body 41 is from a hard plastic material and set in the nail rove 35 in proximity to the nailing nozzle 32, the nail belt 4 does not vibrate during the use of the screw nail gun 2.

Further, injection molding of the belt body 41 must match to the acute angle θ between the nail holder 33 and the nailing surface S, i.e., when the acute angle θ between the nail holder 33 and the nailing surface S is changed, the injection angle of the belt body 41 must be relatively changed.

One of the screw nails 42, namely, the screw nail 421 to be nailed protrudes beyond the alignment face 321 of the nailing nozzle 32 at a distance about 2˜3 mm. The head of the screw nail 421 to be nailed is aimed at a hole B on the workpiece, for example, hinge A that is to be driven into the nailing surface S. By means of aiming the head of the screw nail 421 to be nailed at the hole B of the workpiece A instead of aiming the nailing nozzle 32 at the hole B of the workpiece A, the nailing accuracy is improved, thereby improving construction quality.

As stated above, in order to facilitate operation and to improve construction quality, the invention improvements on the combination of the screw nail gun 3 and the nail belt 4 in two points. At first, the nail groove 35 is designed to define with the nailing surface S an acute angle θ, and the belt body 41 of the nail belt 4 is injection molded from a hard plastic material to match to the acute angle θ. During operation, the nail holder 33 and the belt body 41 do not touch the nailing surface S directly, increasing the level of convenience of use.

Further, the head of the screw nail 421 to be nailed protrudes partially beyond the alignment face 321 of the nailing nozzle 32, facilitating accurate alignment and effectively improving construction quality.

A prototype of combination of screw nail gun and nail belt has been constructed with the features of FIG. 2. The combination of screw nail gun and nail belt functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A combination of screw nail gun and nail belt, comprising:
a screw nail gun, said screw nail gun comprising a gun body extending along an axis perpendicular to a nailing surface, a nailing nozzle connected to a front end of said gun body, said nailing nozzle having a front alignment face, a nail holder connected to said nailing nozzle and defining with said nailing surface an acute angle, and a cover covering said nail holder and defining with said nail holder a nail groove; and
a nail belt set in said nail groove, said nail belt comprising a belt body and a plurality of screw nails fastened to said belt body, each said screw nail having a head, one said screw nail being positioned in said nailing nozzle for nailing, the screw nail positioned in said nailing nozzle having the head thereof partially protruding beyond said front alignment face of said nailing nozzle.

2. The combination of screw nail gun and nail belt as claimed in claim 1, wherein said belt body of said nail belt is injection molded from a hard plastic material and slopes at the same angle of slope relative to said nail groove.

3. The combination of screw nail gun and nail belt as claimed in claim 2, wherein said acute angle is within 20°˜35°.

4. The combination of screw nail gun and nail belt as claimed in claim 3, wherein said acute angle is preferably 26°.

5. The combination of screw nail gun and nail belt as claimed in claim 2, wherein the head of the screw nail positioned in said nailing nozzle partially protrudes beyond said front alignment face of said nailing nozzle at a distance about 2˜3 mm.
